(19) United States
(12) Patent Application Publication
(10) Pub. No.: US 2025/0364817 A1
(43) Pub. Date: Nov. 27, 2025

(54) TOOL ASSEMBLY, ELECTRIC TOOL, BATTERY PACK AND METHOD FOR ADJUSTING POWER OF TOOL ASSEMBLY

(71) Applicant: HANGZHOU GREAT STAR INDUSTRIAL CO., LTD., Hangzhou (CN)

(72) Inventor: Wentian YU, Hangzhou (CN)

(73) Assignee: HANGZHOU GREAT STAR INDUSTRIAL CO., LTD., Hangzhou (CN)

(21) Appl. No.: 18/810,671

(22) Filed: Aug. 21, 2024

Related U.S. Application Data
(63) Continuation of application No. PCT/CN2024/098218, filed on Jun. 7, 2024.

(30) Foreign Application Priority Data
May 21, 2024 (CN) 202410634782.8
May 21, 2024 (CN) 202421135502.0

(51) Int. Cl. H02J 7/00

(52) U.S. Cl. CPC H02J 7/00047; H02J 7/00045; H02J 7/00304; H02J 7/0045

(57) ABSTRACT

A tool assembly, an electric tool, a battery pack and a method for adjusting power of the tool assembly are provided. A tool assembly includes a battery pack, an electric tool and an identification system. The identification system is disposed in the battery pack and/or the electric tool, and the identification system is configured for matching an output power of the battery pack with a power supply power required by the electric tool after the electric tool is plugged into the battery pack. Alternatively, the identification system is disposed in the battery pack and the electric tool, and the identification system is configured for identifiably assembling a battery pack having an output power with an electric tool having a power supply power matching with the output power of the battery pack.

### CROSS-REFERENCE TO RELATED APPLICATIONS

This application is a continuation of international patent application No. PCT/CN2024/098218, filed on Jun. 7, 2024, which itself claims priority to Chinese patent application Nos. 202410634782.8, filed on May 21, 2024, and titled “TOOL ASSEMBLY, ELECTRIC TOOL, BATTERY PACK AND METHOD FOR ADJUSTING POWER OF TOOL ASSEMBLY”; 202421135502.0, filed on May 21, 2024, and titled “TOOL ASSEMBLY, ELECTRIC TOOL, AND BATTERY PACK”. The contents of the above identified applications are hereby incorporated herein in their entireties by reference.

### TECHNICAL FIELD

The present disclosure relates to the field of tools technology, and in particular, to a tool assembly, an electric tool, a battery pack and a method for adjusting power of the tool assembly.

### BACKGROUND

An electric tool is generally used in conjunction with a battery pack. Different electric tools generally require different power supplies. A maximum output voltage and a maximum output current are generally set for the battery pack. If the electric tool is plugged into a mismatched battery pack, the electric tool or an internal chip of the battery pack will be damaged. However, a unique matching between the electric tool and the battery pack will lead to the need to carry multiple corresponding matching battery packs when using a variety of the electric tools, resulting in high cost and extremely inconvenience.

### SUMMARY

According to the embodiments of the present disclosure, a tool assembly, an electric tool, a battery pack and a method for adjusting power of the tool assembly are provided.

A tool assembly is provided in the present disclosure. The tool assembly includes a battery pack and an electric tool. The electric tool is capable of being plugged into and connected with the battery pack along a plugging direction of the electric tool, and the battery pack is configured for charging or supplying power to the electric tool. The tool assembly further includes an identification system, the identification system is disposed in the battery pack and/or the electric tool, and the identification system is configured for matching an output power of the battery pack with a power supply power required by the electric tool after the electric tool is plugged into the battery pack. Alternatively, the identification system is disposed in the battery pack and the electric tool, and the identification system is configured for identifiably assembling the battery pack having an output power with the electric tool having a power supply power matching with the output power of the battery pack.

In some embodiments, the identification system includes a signal identification device. The signal identification device includes a signal receiver, an output power adjusting structure and a signal feedback element. The signal receiver and the output power adjusting structure are disposed on the battery pack, and the signal feedback element is disposed on the electric tool; the signal feedback element is capable of being electrically connected with the signal receiver and sending a power supply value signal required by the electric tool to the signal receiver after the electric tool is plugged into the battery pack. The output power adjusting structure is electrically connected to the signal receiver and configured for adjusting the output power of the battery pack according to the power supply value signal received via the signal receiver, so as to make the output power of the battery pack match with the power supply power required by the electric tool.

In some embodiments, the signal receiver and the output power adjusting structure are integrally formed.

In some embodiments, the identification system includes a structure identification device. The structure identification device includes a first identification structure and a second identification structure. The first identification structure is disposed on the battery pack and the second identification structure is disposed on the electric tool. Both the first identification structure and the second identification structure extend along the plugging direction of the electric tool. And the first identification structure matches with the second identification structure, so that the battery pack having the output power is identifiably assembled with the electric tool having the power supply power matching with the output power of the battery pack.

In some embodiments, the first identification structure includes a plurality of grooves, and the second identification structure includes at least one protrusion corresponding to at least a part of the plurality of grooves.

In some embodiments, the number of the at least one protrusion in the second identification structure is less than or equal to the number of the grooves in the first identification structure, and the electric tools with the different second identification structures are capable of plugging into and matching with the same battery pack.

In some embodiments, the electric tool further includes a mounting component and an electrode sheet, the electrode sheet includes a positive electrode sheet and a negative electrode sheet, and the positive electrode sheet, the negative electrode sheet and the at least one protrusion are all fixed to the mounting component.

In some embodiments, a plurality of protrusions are disposed on the same electric tool, and shapes of the plurality of protrusions are different and/or heights of the plurality of protrusions are different.

The present disclosure further provides an electric tool, the electric tool is the above electric tool.

The present disclosure further provides a battery pack, the battery pack is the above battery pack.

The present disclosure further provides a method for adjusting a power of a tool assembly, which is applied to the above tool assembly, the method includes the following steps:
plugging the electric tool into the battery pack, and obtaining a power supply value signal required by the electric tool via the signal receiver;
transmitting the power supply value signal to the output power adjusting structure; and
adjusting the output power of the battery pack by the output power adjusting structure according to the power supply value signal, so as to make the output power of the battery pack match with the power supply power required by the electric tool.

Details of one or more embodiments of the present disclosure are presented in the attached drawings and descriptions below. And other features, purposes and advantages of the present disclosure will become apparent from the description, drawings and claims.

### BRIEF DESCRIPTION OF THE DRAWINGS

For a better description and illustration of embodiments and/or examples of those disclosures disclosed herein, reference may be made to one or more attached drawings. Additional details or examples used to describe the drawings should not be considered as limiting the scope of any of the disclosed disclosures, currently described embodiments and/or examples, and currently understood best modes of these disclosures.

FIG. 1 is a schematic view of a structure of a part of a tool assembly in an embodiment.

FIG. 1A is a schematic view of a structure of a part of the tool assembly in FIG. 1.

FIG. 2 is a structural schematic view of the battery pack in FIG. 1.

FIG. 3 is a schematic view of a structure of a part of the tool assembly in FIG. 1.

FIG. 4 is a schematic view of a structure of part of a tool assembly in another embodiment.

FIG. 5 is a structural schematic view of the battery pack in FIG. 4.

FIG. 6 is a schematic view of a structure of a part of the tool assembly in FIG. 4.

FIG. 7 is a schematic view of the electric tool in FIG. 6 from another angle.

FIG. 8 is a schematic view of the structure of a part of an electric tool in another embodiment.

FIG. 9 is a schematic view of the structure of a part of an electric tool in another embodiment.

FIG. 10 is a schematic view of the structure of a part of an electric tool in another embodiment.

FIG. 11 is a structural schematic view of a battery pack in another embodiment.

FIG. 12 is a schematic view of a structure of a part of an electric tool in another embodiment.

FIG. 13 is a structural schematic view of a battery pack in another embodiment.

FIG. 14 is an enlarged view of portion X in FIG. 13.

FIG. 15 is a schematic view of a structure of a part of an electric tool in another embodiment.

FIG. 16 is a structural schematic view of a battery pack in another embodiment.

FIG. 17 is a schematic view of a structure of a part of an electric tool in another embodiment.

FIG. 18 is a structural schematic view of a battery pack in another embodiment.

100 represents an identification system; 101 represents a signal identification device; 102 represents a structure identification device; 10 represents a battery pack; 11 represents an electrode groove; 12 represents a second identification structure; 121 represents a second guiding surface; 13 represents a signal receiver; 14 represents an output power adjustment structure; 15 represents a charging port; 20 represents a mounting component; 21 represents an electrode sheet; 211 represents a positive electrode sheet; 212 represents a negative electrode sheet; 22 represents a first identification structure; 221 represents a first guiding surface; 23 represents a signal feedback element; A represents an plugging direction; and 201 represents an electric tool.

### DETAILED DESCRIPTION

The technical scheme in the embodiment of the present disclosure will be described clearly and completely with the attached drawings. Obviously, the described embodiment is only a part of the embodiment of the present disclosure, not the whole embodiment. Based on the embodiments in the present disclosure, all other embodiments obtained by ordinary technicians in this field without creative work belong to the protection scope of the present disclosure.

It should be noted that when a component is considered to be “mounted” on another component, it can be directly on the other component or there can be a component in the middle. When a component is considered to be “set on” another component, it can be directly set on another component or there may be intervening components at the same time. When a component is considered to be “fixed” to another component, it can be directly fixed to another component or there may be intervening components at the same time.

Unless otherwise defined, all technical and scientific terms used herein have the same meaning as commonly understood by those skilled in the technical field of the present disclosure. The terminology used herein in the specification of the present disclosure is only for the purpose of describing specific embodiments, and is not intended to limit the present disclosure. As used herein, the term “or/and” includes any and all combinations of one or more related listed items.

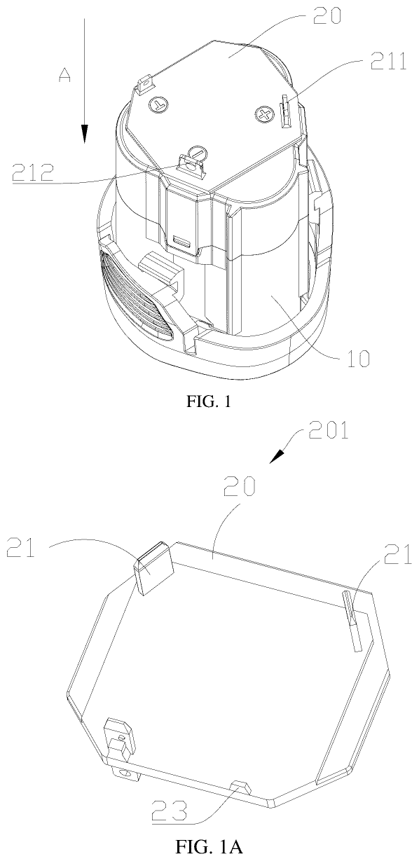

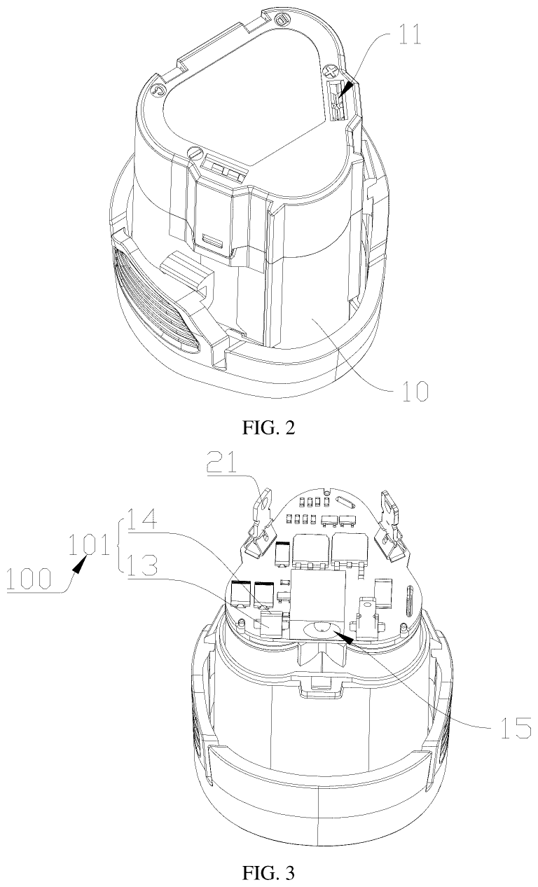

Referring to FIG. 1 to FIG. 3, the tool assembly includes an electric tool 201 (the whole structure is not shown in the figure) and a battery pack 10. The electric tool 201 is generally used in conjunction with the battery pack 10. The electric tool 201 can be plugged into and connected with the battery pack 10 along a plugging direction (A direction in FIG. 1) of the electric tool 201, and the battery pack 10 is used for charging or supplying power to the electric tool 201. The electric tool 201 is a tool that drives a working head via a transmission mechanism, and the electric tool 201 can be an electric screwdriver, an electric wrench, an electric drill, etc.

The electric tool 201 includes an electric tool body (not shown), a mounting component 20 and an electrode sheet 21. The mounting component 20 is fixed at an end of the electric tool body. And the electrode sheet 21 includes a positive electrode sheet 211 and a negative electrode sheet 212. Both the positive electrode sheet 211 and the negative electrode sheet 212 are fixed to the mounting component 20. In some embodiments, the mounting component 20 can be sheet shaped. It can be understood that in other embodiments, the mounting component 20 can be in other shapes, and can also be integrally formed with the electric tool body.

The battery pack 10 is provided with an electrode groove 11 corresponding to the electrode sheet 21, and the electrode groove 11 includes a positive electrode groove and a negative electrode groove. The positive electrode groove and the negative electrode groove are corresponding to the positive electrode sheet 211 and the negative electrode sheet 212, respectively.

An electric tool 201 is generally used in conjunction with a battery pack. Different electric tools 201 generally require different power supplies. A maximum output voltage and a maximum output current are generally set for the battery pack. If the electric tool 201 is plugged into a mismatched battery pack, the electric tool 201 or an internal chip of the battery pack will be damaged. However, an unique matching between the electric tool 201 and the battery pack will lead to the need to carry multiple corresponding matching battery packs when using a variety of the electric tools 201, which is costly and extremely inconvenient.

For example, the battery pack 10 and the electric tool 201 are triangular plug-in structures that match with each other. However, the battery pack 10 is a 20V battery pack 10, but a voltage that the electric tool 201 adapts is 12V. Although the electric tool 201 can be successfully plugged into the battery pack 10, after plugging, the output power of the battery pack 10 is obviously too great in the working state, which easily leads to burning of the motor of the electric tool 201. On the contrary, the battery pack 10 is a 12 V battery pack 10, and a voltage that the electric tool 201 adapts is 20V. After the electric tool 201 is successfully plugged into the battery pack 10, in the working state, the output power of the battery pack 10 is obviously difficult to meet requirements of the electric tool 201. Although the electric tool 201 will not be damaged, it is difficult to give full play to a performance of the electric tool 201.

In order to solve the above problems, the tool assembly in the present disclosure is further provided with an identification system 100. The identification system 100 is disposed in the battery pack 10 and/or the electric tool 201, and the identification system 100 is configured for matching an output power of the battery pack 10 with a power supply power required by the electric tool 201 after the electric tool 201 is plugged into the battery pack 10. Optionally, the identification system 100 is disposed in the battery pack 10 and the electric tool 201, and the identification system 100 is configured for identifiably assembling the battery pack 10 having an output power with the electric tool 201 having a power supply power matching with the output power of the battery pack 10.

In this way, users can match the output power of the battery pack 10 with a power supply power required by the electric tool 201 via the identification system 100 after the electric tool 201 is plugged into the battery pack 10, or prevent use of the battery pack 10 from being plugged with an electric tool 201 having a mismatching supply power, thereby protecting the electric tool 201 and the battery pack 10, prolonging a service life of the electric tool 201 or prolonging a service life of the battery pack 10, and effectively improving universality of the battery pack 10, reducing an overall cost, and improving a work convenience of users.

The phrase “the output power of the battery pack 10 matches with the power supply power required by the electric tool 201” means that the battery pack 10 can output the p required by different electric tools 201 in different states. In other words, the battery pack 10 does not match with only one certain kind of the electric tool 201 or a certain electric tool 201, the battery pack 10 can be matched with a plurality of electric tools 201. Specifically, the electric tool 201 generally has a rated power, and the rated power is defined as P. Correspondingly, a rated current value that the electric tool 201 can bear is defined as I. It is easy to damage the electric tool 201 when the rated power exceeds a certain preset range or the rated current value exceeds a certain preset range.

For example, if three different kinds of electric tools 201 need to be carried at the same time when processing a certain job, the “preset range” of the above is set as 10%, the rated powers of the three electric tools 201 are defined as P₁, P₂ and P₃, respectively, and the corresponding rated current values are defined as I₁, I₂ and I₃. The maximum output power that the electric tools 201 can bear is P₁+10% P₁, P₂+10% P₂ and P₃+10% P₃, respectively, and the maximum output current that the electric tools 201 can bear is I₁+10% I₁, I₂+10% I₂ and I₃+10% I₃, respectively. At this time, “the output power of the battery pack 10 match with the power supply power required by the electric tool 201” means that when the battery pack 10 is plugged into the corresponding three electric tools 201, respectively, the maximum output power of the battery pack 10 is less than or equal to P₁+10% P₁, P₂+10% P₂ and P₃+10% P₃ respectively, and the maximum output current of the battery pack 10 is less than or equal to I₁+10% I₁, I₂+10% I₂ and I₃+10% I₃, respectively. In this way, it can be ensured that the battery pack 10 can be plugged into different electric tools 201, and at the same time, it can meet the requirements of different electric tools 201 in different states, and will not output power and current beyond the tolerance range of the electric tools 201, thus ensuring a safety of the electric tools 201. It can be understood that the above-mentioned “preset range” can be set according to a specific situation, which is not limited herein.

Furthermore, the electric tool 201 generally has a no-load state and a loaded state. In the no-load state, the electric tool 201 does not drive external components, so there is no extra consumption, and a required power supply power is small. At this time, the output power or the discharge current of the battery pack 10 can be reduced, as long as the requirements of the electric tool 201 in the no-load state can be met. When the electric tool 201 is in the loaded state, that is, when external parts are connected and driven by the electric tool 201 to work, a great consumption is required, and the required power supply power or the required current value will rise sharply at this time. At this time, the output power or discharge current of the battery pack 10 needs to reach or meet the required rated power and current value of the electric tool 201. It can be understood that the output power and discharge current of the battery pack 10 are not completely stable values, and there may be a small range of fluctuations in the process of matching with the electric tool 201, but the fluctuations will not exceed the maximum power or current that the electric tool 201 can bear while meeting the requirements of the electric tool 201 at that time.

Similarly, it can be understood that “the battery pack 10 having the output power is identifiably assembled with the electric tool 201 having the power supply power matching with the output power of the battery pack 10” means that the battery pack 10 has a fixed maximum output power and a fixed maximum output current, which are not adjustable. Thus, the electric tools 201 with different rated powers cannot be met at the same time, and only one type of the electric tool 201 matching with the electric tool 201 can be met. For example, when the rated power of a certain type of the electric tool 201 is defined as P₄, the rated current of the electric tool 201 is defined as I₄, and the preset range is set to 10%, the maximum output power and maximum output current of the battery pack 10 that can be successfully plugged into the electric tool 201 must be P₄+10% P₄ and I₄+10% I₄. In other words, the matching relationship between the electric tool 201 and the battery pack 10 is unique.

Referring to FIG. 1 to FIG. 3, illustratively, in one embodiment of the present disclosure, the identification system 100 includes a signal identification device 101. The signal identification device 101 includes a signal receiver 13, an output power adjustment structure 14 and a signal feedback element 23. The signal receiver 13 and the output power adjustment structure 14 are disposed on the battery pack 10, and the signal feedback element 23 is disposed on the electric tool 201. The signal feedback element 23 is capable of being electrically connected with the signal receiver 13 and sending a power supply value signal required by the electric tool 201 to the signal receiver 13 after the electric tool 201 is plugged into the battery pack 10. The output power adjustment structure 14 is electrically connected to the signal receiver 13 and configured for adjusting the output power of the battery pack 10 according to the power supply value signal received via the signal receiver 13, so as to make the output power of the battery pack 10 match with the power supply power required by the electric tool 201, that is, in the present embodiment, the signal identification device 101 can make the identification system 100 in an adjustment mode, and the output power of the battery pack 10 can be adjusted to match with different electric tools 201.

In this way, the different electric tool 201 can be matched and plugged with the same the battery pack 10. The signal receiver 13 of the battery pack 10 can receive the power supply power value signal fed back by the signal feedback element 23 in the electric tool 201, so that the output power adjustment structure 14 in the battery pack 10 can adjust the output power of the battery pack 10 according to the power supply power value signal. Therefore, the electric tool 201 with different requirements of the power supply power can be adapted to the same battery pack 10, conditions of damaging to internal chips of the electric tool 201 or the battery pack 10 can be avoided, a working performance of the tool is effectively improved, the service life of different electric tools 201 are prolonged and an universality of the battery pack 10 is improved. In addition, users do not need to buy and carry a variety of battery packs 10 when working, which effectively reduces a working cost and improves a working convenience.

Specifically, the output power adjustment structure 14 can take corresponding measures to limit a discharge current of the battery pack 10 (that is, an output current of the battery pack 10) when adjusting the maximum output power of the battery pack 10 to match with different electric tools 201. Illustratively, the measures and structure for limiting the output current of the battery pack 10 are shown hereinafter.

### First Mode: Series Resistor Current-Limiting.

A resistor is connected in series between the positive electrode and negative electrode of the battery, and the resistance value is selected according to the actual demand. When the current flows through the resistor, it will produce a certain voltage drop, thus limiting the discharge current of the battery pack 10.

### Second Mode: MOS Transistor Current-Limiting.

MOSFET (Metal Oxide Semiconductor Field Effect Transistor) can be used to realize current-limiting. MOSFET has a low internal resistance and a low dynamic response speed, and an impedance of the MOSFET can be changed by controlling the gate voltage, thus realizing the current-limiting control of the discharge current of the battery pack 10.

Third Mode: Current-Limiting with a Linear Voltage Regulator.

The linear voltage regulator puts a large capacitor through polarity, so that the large capacitor can provide a part of the current at the instantaneous peak of the current, thus playing a buffering role, thus realizing the current-limiting control of the discharge current of the battery pack 10.

### Fourth Mode: PWM Current-Limiting.

PWM (Pulse Width Modulation) technology can quickly switch on and off the switching elements in the circuit, thus realizing the current-limiting control of the discharge current of the battery pack 10. The PWM can play an effective control role in current-limiting, and the control is easy to realize.

It can be understood that various measures can be taken to limit the discharge current of the battery pack 10, including but not limited to the above-mentioned first model to fourth model, and an appropriate method can be selected according to an actual situation. At the same time, it is necessary to determine the method of limiting current and the limited current according to characteristics and working requirements of equipment.

Furthermore, it can be understood that the signal receiver 13 and the output power adjustment structure 14 can be separately formed or integrally formed. Referring to FIG. 3, in the present embodiment, in order to reduce a required installation space and improve an adjustment efficiency, the signal receiver 13 and the output power adjustment structure 14 are integrally formed.

Furthermore, it should be noted that in some embodiments, when the electric tool 201 is not provided with the signal feedback element 23 or the signal feedback element 23 fails to send the power supply power value signal to the signal receiver 13, that is, when the signal receiver 13 does not receive the power supply power value signal, the identification system 100 will switch from the adjustment mode to a protection mode. The output power adjustment structure 14 of the signal identification device 101 will adjust the output power of the battery pack 10 to a preset minimum output power to avoid damaging the electric tool 201. The preset minimum the output power is set according to the actual situation, which is not limited herein.

Furthermore, the battery pack 10 and the electric tool 201 can be further provided with a power-off protection structure to prevent the battery pack 10 from discharging greatly in a short time or prevent the electric tool 201 from receiving excessive discharge current. For example, a generation of current in some devices is related to the cutting of magnetic induction lines. When the electric tool 201 is connected with external parts and the magnetic induction lines are cut rapidly, a current will rise sharply and a voltage will drop. When a value of the current is too high and a value of the voltage is too low, in order to prevent internal damage, the power-off protection structure can be automatically started to realize self-protection, that is, an electrical connection between the battery pack and the electric tool 201 is disconnected. The power-off protection structure can be arranged in the battery pack 10 or the electric tool 201. In most cases, the electric tool 201 will have its own power-off protection structure.

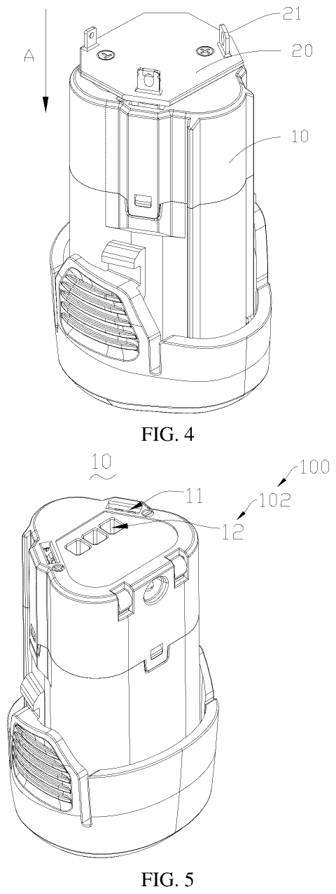

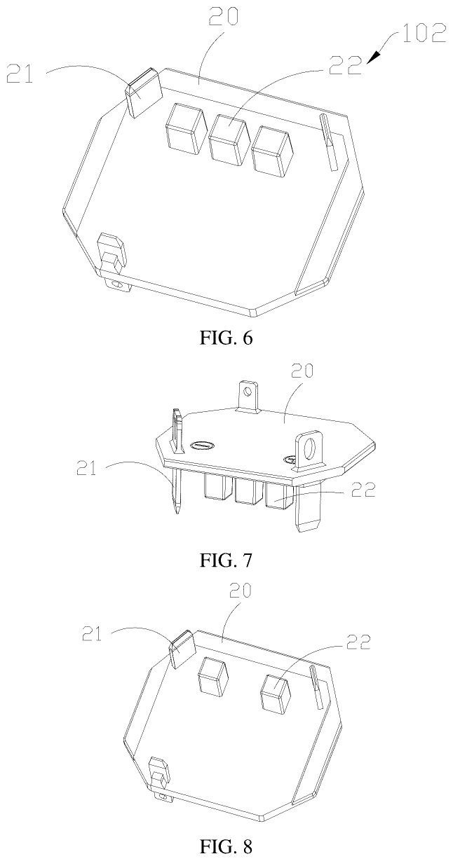

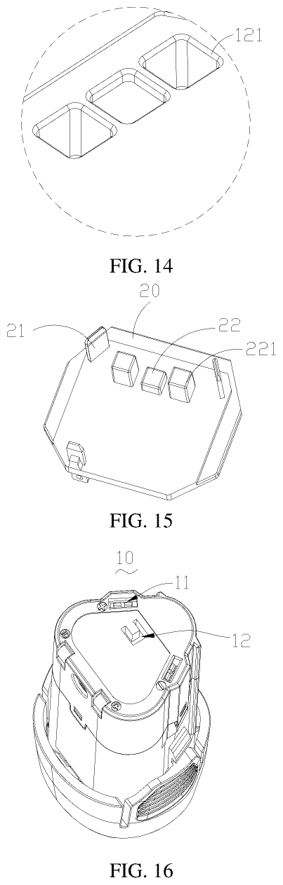

Referring to FIG. 4 to FIG. 18, in other embodiments of the present disclosure, the identification system 100 includes a structure identification device 102. The structure identification device 102 includes a first identification structure 22 and a second identification structure 12. The first identification structure 22 is disposed on the battery pack 10, and the second identification structure 12 is disposed on the electric tool 201. Both the first identification structure 22 and the second identification structure 12 extend along the plugging direction A of the electric tool 201. And the first identification structure 22 matches with the second identification structure 12, so that the battery pack 10 having the output power is identifiably assembled with the electric tool 201 having the power supply power matching with the output power of the battery pack 10. In other words, the battery pack 10 is provided with a first identification structure 22, and the electric tool 201 is provided with a second identification structure 12. Both the first identification structure 22 and the second identification structure 12 extend along the plugging direction. The first identification structure 22 and the second identification structure 12 are matched with each other, so that the battery pack 10 and the electric tool 201 can be identifiably assembled.

In this way, the user can judge whether the electric tool 201 and the battery pack 10 match each other via the first identification structure 22 and the second identification structure 12, so as to prevent the battery pack 10 from being plugged with the unmatched electric tool 201, and to prolong the service life of the electric tool 201 or the service life of the battery pack 10. That is, when the battery pack 10 is plugged into the electric tool 201, the first identification structure 22 and the second identification structure 12, which cannot be matched with each other, can prevent the battery pack 10 and the electric tool 201 from being completely plugged and connected, so as to prevent the battery pack 10 from being plugged with an electric tool 201 having a power supply power does match with the output power of the battery pack, thereby avoiding conditions that the chips or other structures of the battery pack 10 or the electric tool 201 are damaged.

It can be understood that the structure identification device 102 ensures the plug-in use of the electric tool 201 and the adapted battery pack 10 via a mechanical structure design. That is, only the battery pack 10 that ensures that the output power matches the power supply power required by the electric tool 201 can be successfully plugged into the electric tool 201. It can be understood that, the battery pack 10 has a fixed maximum output power and maximum output current, which is not adjustable and cannot meet the requirements of the electric tool 201 with different rated powers at the same time. And the signal identification device 101 flexibly adjusts the output power of the battery pack 10 through signal reception and identification. That is, the signal identification device 101 makes the maximum output power and maximum output current of the battery pack 10 adjustable. The output power of the battery pack 10 can be adjusted to a state adapted to the electric tool 201 according to the requirements of the plugged electric tool 201, so as to ensure the safety after the electric tool 201 is plugged into the battery pack 10 and give full play to the performance of the electric tool 201.

Illustratively, in some embodiments, the first identification structure 22 includes a plurality of grooves, and the second identification structure 12 includes a protrusion corresponding to at least a part of the plurality of grooves.

The second identification structure 12 on the electric tool 201 can be a protrusion. If a battery pack 10 without a groove structure is assembled with the electric tool 201, the protrusion will hinder the electric tool 201 from advancing, thereby preventing the electric tool 201 from being plugged into and assembled with the battery pack 10 by mistake, and protecting a chip of the electric tool 201 and a chip of the battery pack 10.

It can be understood that the first identification structure 22 can be a protrusion, and correspondingly, the second identification structure 12 can be a groove. Alternatively, some structures in the first identification structure 22 are set as protrusions and others are set as grooves. Correspondingly, some structures in the second identification structure 12 are set as grooves and others are set as protrusions. The concave-convex structure can prevent the electric tool 201 and the battery pack 10 from being inserted and assembled by mistake, thus protecting a chip of the electric tool 201 and a chip of the battery pack 10.

It is particularly important to note that the number of protrusions and the number of grooves may be the same, or the number of protrusions may be smaller than the number of grooves. Referring to FIG. 5 to FIG. 10, in some embodiments, the number of protrusions in the second identification structure 12 is less than or equal to the number of grooves in the first identification structure 22, the electric tool 201 with different second identification structures 12 can be plugged and matched with the same battery pack 10.

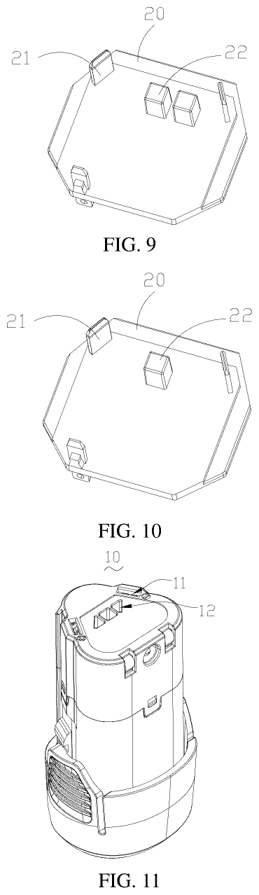

Specifically, the battery pack 10 in FIG. 5 is provided with three rectangular prism-shape grooves, and the mounting components 20 in FIG. 7 and FIG. 8 are correspondingly provided with three rectangular prism-shape protrusions. When the electric tool 201 provided with the mounting component 20 is plugged into the battery pack 10 in FIG. 5, the three protrusions are inserted into three grooves, respectively. The mounting component 20 in FIG. 9 is provided with two rectangular prism-shape protrusions, and the mounting component 20 in FIG. 10 is provided with only one protrusion. When the electric tool 201 provided with the mounting component 20 in FIG. 9 or FIG. 10 is plugged with the battery pack 10 in FIG. 5, only part of the grooves is utilized, and the rest of the grooves are in a vacant state.

In this way, the electric tool 201 of different models can also be matched with the battery pack 10 of the same model, which can save a production cost.

In some embodiments, along the plugging direction A, a height of the protrusion is not higher than a height of the positive electrode sheet 211 or a height of the negative electrode sheet 212. In this way, an original size of the electric tool 201 along the plugging direction A will not be increased. Of course, the height of the protrusion can be higher than the height of the positive electrode sheet 211 or the height of the negative electrode sheet 212, which is not limited herein.

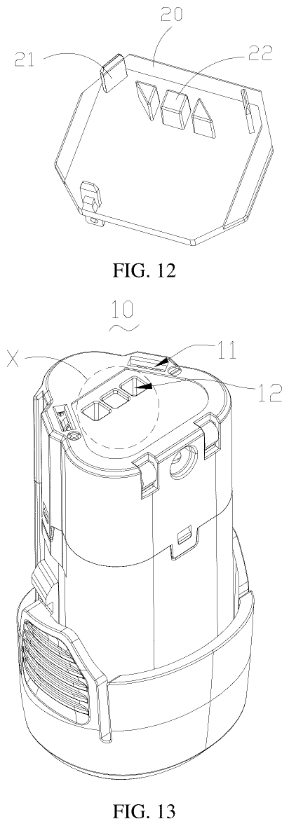

In some embodiments, referring to FIG. 11 to FIG. 15, the mounting component 20 of the same electric tool 201 is provided with a plurality of protrusions with different shapes and/or heights. Specifically, referring to FIG. 11 and FIG. 12, the protrusions can be arranged in a combined structure of triangular prisms and rectangular prism, and the grooves can also be in a combined structure of triangular prisms and rectangular prism. Referring to FIG. 13 to FIG. 15, the heights of the protrusions can be different, and depths of the corresponding grooves are also different. It can be understood that in some unillustrated embodiments, the shapes and heights of the protrusions may be different, as long as the protrusions can be inserted into the grooves, which is not limited herein.

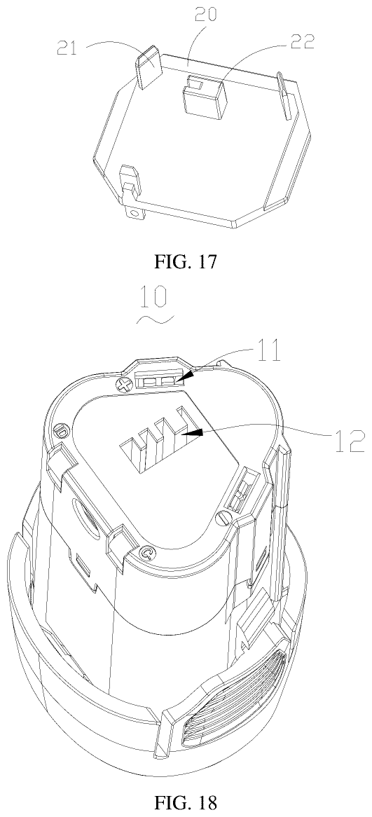

In some embodiments, referring to FIG. 16 to FIG. 18, the protrusion has a column-shape structure, and a cross-sectional shape of the protrusions is irregular. Specifically, the cross-sectional of the protrusions can be rectangular shape, triangle, oval, rhombic shape, regular polygon or other non-circular shapes, as long as the protrusions can be inserted into the grooves. Referring to FIG. 16 and FIG. 17, both the protrusion and the groove are in an irregular shape. Referring to FIG. 18, a shape of the groove is a combination of a plurality of rectangles.

In some embodiments, referring to FIG. 13 and FIG. 14, a side of the protrusion adjacent to the groove is provided with a chamfer and defines the first guiding surface 221. In some embodiments, a side of the protrusion adjacent to the groove is provided with a chamfer and defines the second guiding surface 121. In this way, when the protrusion is plugged into the groove, smoothness of the plugging process can be increased. Especially, after the electrode sheet 21 is partially inserted into the electrode groove 11, a design of the first guiding surface 221 and a design of the second guiding surface 121 can avoid adverse effects such as shaking and displacement on an insertion of the electrode sheet 21 into the electrode groove 11 when protrusions and grooves are inserted.

The present disclosure further provides an electric tool 201, and the electric tool 201 is the electric tool 201 described above.

The present disclosure further provides a battery pack 10, the battery pack 10 is the battery pack 10 described above. Furthermore, the battery pack 10 is provided with a charging port 15. When the battery pack 10 is short of electricity or exhausted, the battery pack 10 can be charged at the charging port 15. A size of a connector of the charging port 15 of the battery pack 10 can be in a range of 2.5 mm to 3.5 mm. Referring to FIG. 3, in an embodiment, the size of the connector of the charging port 15 of the battery pack 10 is 3.2 mm.

The present disclosure further provides a method for adjusting a power of a tool assembly, which is applied to the above tool assembly. The method includes the following steps:
S1, plugging the electric tool 201 into the battery pack 10, and obtaining a power supply value signal required by the electric tool 201 via the signal receiver 13;
S2, transmitting the power supply value signal to the output power adjusting structure 14; and
S3, adjusting the output power of the battery pack 10 by the output power adjusting structure 14 according to the power supply value signal, so as to make the output power of the battery pack 10 match with the power supply power required by the electric tool 201.

The specific meaning of “the output power of the battery pack 10 match with the power supply power required by the electric tool 201” can be referred to above, and is repeated herein.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments express only several embodiments of the present application, which are described in a more specific and detailed manner, but are not to be construed as a limitation of the scope of the patent application. It should be pointed out that for a person of ordinary skill in the art, several deformations and improvements can be made without departing from the conception of the present application, and these fall within the scope of protection of the present application. Therefore, the scope of patent protection of the present application shall be subject to the attached claims.

What is claimed is:

1. A tool assembly, comprising a battery pack and an electric tool,
wherein the electric tool is capable of being plugged into and connected with the battery pack along a plugging direction of the electric tool, and the battery pack is configured for charging or supplying power to the electric tool,
the tool assembly further comprises an identification system, wherein the identification system is disposed in the battery pack and/or the electric tool, and the identification system is configured for matching an output power of the battery pack with a power supply power required by the electric tool after the electric tool is plugged into the battery pack; or, the identification system is disposed in the battery pack and the electric tool, and the identification system is configured for identifiably assembling the battery pack having an output power with the electric tool having a power supply power matching with the output power of the battery pack.

2. The tool assembly of claim 1, wherein the identification system comprises a signal identification device, the signal identification device comprises a signal receiver, an output power adjusting structure and a signal feedback element; the signal receiver and the output power adjusting structure are disposed on the battery pack, and the signal feedback element is disposed on the electric tool;
the signal feedback element is capable of being electrically connected with the signal receiver and sending a power supply value signal required by the electric tool to the signal receiver after the electric tool is plugged into the battery pack; the output power adjusting structure is electrically connected to the signal receiver and configured for adjusting the output power of the battery pack according to the power supply value signal received via the signal receiver, so as to make the output power of the battery pack match with the power supply power required by the electric tool.

3. The tool assembly of claim 2, wherein the signal receiver and the output power adjusting structure are integrally formed.

4. The tool assembly of claim 1, wherein the identification system comprises a structure identification device, the structure identification device comprises a first identification structure and a second identification structure; the first identification structure is disposed on the battery pack and the second identification structure is disposed on the electric tool; both the first identification structure and the second identification structure extend along the plugging direction of the electric tool; and the first identification structure matches with the second identification structure, so that the battery pack having the output power is identifiably assembled with the electric tool having the power supply power matching with the output power of the battery pack.

5. The tool assembly of claim 4, wherein the first identification structure comprises a plurality of grooves, and the second identification structure comprises at least one protrusion corresponding to at least a part of the plurality of grooves.

6. The tool assembly of claim 5, wherein the number of the at least one protrusion in the second identification structure is less than or equal to the number of the grooves in the first identification structure, and the electric tools with the different second identification structures are capable of plugging into and matching with the same battery pack.

7. The tool assembly of claim 5, wherein the electric tool further comprises a mounting component and an electrode sheet, the electrode sheet comprises a positive electrode sheet and a negative electrode sheet, and the positive electrode sheet, the negative electrode sheet and the at least one protrusion are all fixed to the mounting component.

8. The tool assembly of claim 5, wherein a plurality of protrusions are disposed on the same electric tool, and shapes of the plurality of protrusions are different and/or heights of the plurality of protrusions are different.

9. An electric tool, wherein the electric tool is the electric tool of claim 1.

10. A battery pack, wherein the battery pack is the battery pack of claim 1.

11. A method for adjusting a power of a tool assembly, which is applied to the tool assembly of claim 1, wherein the method comprises the following steps:
plugging the electric tool into the battery pack, and obtaining a power supply value signal required by the electric tool via the signal receiver;
transmitting the power supply value signal to the output power adjusting structure; and
adjusting the output power of the battery pack by the output power adjusting structure according to the power supply value signal, so as to make the output power of the battery pack match with the power supply power required by the electric tool.
